(19) United States
(12) Patent Application Publication
(10) Pub. No.: US 2016/0166986 A1
(43) Pub. Date: Jun. 16, 2016

(54) METHOD FOR PURIFICATION OF OFF-GAS AND DEVICE FOR THE SAME

(71) Applicant: HANWHA CHEMICAL CORPORATION, Jung-gu Seoul (KR)

(72) Inventors: Gil Ho KIM, Daejeon (KR); Won Ik LEE, Bucheon (KR); Gui Ryong AHN, Daejeon (KR); Bo Kyung KIM, Daejeon (KR)

(73) Assignee: HANWHA CHEMICAL CORPORATION, Seoul (KR)

(21) Appl. No.: 14/905,983

(22) PCT Filed: Aug. 12, 2014
(86) PCT No.: PCT/KR2014/007495

§ 371 Date: Jan. 19, 2016

(30) Foreign Application Priority Data
Aug. 28, 2013 (KR) 10-2013-0102573

(51) Int. Cl. B01D 53/86

(52) U.S. Cl. CPC B01D 53/8659; B01D 2258/0216; B01D 2257/2045; B01D 2255/207; B01D 2255/1021

(57) ABSTRACT

This disclosure relates to a method for purification of off-gas and a device for the same. More particularly, this disclosure relates to a method for purification of off-gas that removes hydrogen chloride from the off-gas discharged after conducting a polysilicon deposition process by chemical vapor deposition, and can separate hydrogen of high purity, and a device for the same.

### TECHNICAL FIELD

This disclosure relates to a method for purification of off-gas and a device for the same. More particularly, this disclosure relates to a method for purification of off-gas that removes hydrogen chloride from the off-gas discharged after conducting a polysilicon deposition process by chemical vapor deposition, and can separate hydrogen of high purity, and a device for the same.

This application claims the benefit of Korean Patent Application No. 10-2013-0102573 filed on Aug. 28, 2013 in the Korean Intellectual Property Office, the entire disclosure of which is herein incorporated by reference.

### BACKGROUND ART

One of the methods known to produce polysilicon for a solar cell is by deposition of polysilicon in a chemical vapor deposition (CVD) reactor, which is known as a Siemens process.

In the Siemens process, silicon filaments are commonly exposed to trichlorosilane together with carrier gas at high temperature of 1000° C. or more. The trichlorosilane gas is decomposed into silicon by the following Formula 1 and the silicon is deposited on the heated silicon filaments, thus growing the heated silicon filaments.

2HSiCl₃->Si+2HCl+SiCl₄ [Formula 1]

After conducting the polysilicon deposition process by chemical vapor deposition, chlorosilane compounds such as dichlorosilane, trichlorosilane or silicon tetrachloride, hydrogen and hydrogen chloride are discharged.

The off-gas (OGR) comprising chlorosilane compounds, hydrogen and hydrogen chloride is generally recovered and recycled through the 4 steps of 1) condensing & compression process, 2) HCl absorption & distillation process, 3) hydrogen (H₂) adsorption process, and 4) separation process of chlorosilane compounds.

More specifically, the off-gas that is discharged from the polysilicon deposition reactor is transferred to the condensing & compression process, cooled and introduced into a knock-out drum. And, it is separated according to temperature, the condensed phase stream of chlorosilane compounds is transferred to the HCl distillation column in the absorption & distillation process, and the non-condensed phase stream is cooled and compressed and then transferred to the bottom of the HCl absorption column. The compositional ratio of hydrogen (H₂) in the non-condensed phase stream is about 90 mol % or more.

The non-condensed phase stream that is introduced from the absorption & distillation process is cooled, and then, introduced in the HCl absorption column. The condensed phase stream from which hydrogen chloride has been removed in the HCl distillation column is sprayed and mixed at the top of the absorption column, and chlorosilane compounds and hydrogen chloride in the non-condensed phase stream are absorbed and removed.

The hydrogen stream from which most chlorosilane compounds and hydrogen chloride have been removed is introduced into a column filled with activated carbon, remaining chlorosilane compounds and hydrogen chloride are adsorbed, and high purity hydrogen is recovered.

The above explained hydrogen purification process is a pressure swing adsorption (PSA) process, and it is used for the separation and purification of polysilicon off-gas.

The pressure swing adsorption process has disadvantages in that energy efficiency is low because it consists of condensing and compression process, and maintenance cost is high because it is a physical process. And, in the pressure swing adsorption process, the adsorption process is a process of preparing high purity hydrogen by selectively adsorbing and removing gas desired to be removed among hydrogen chloride, hydrogen and chlorosilane compounds using activated carbon, the activated carbon regeneration process is a process of desorbing adsorbed material from the polluted adsorbent by hydrogen chloride and chlorosilane compounds, and the adsorption process and the regeneration process are alternatively conducted in at least two adsorption column. However, the existing pressure swing adsorption device has disadvantages in that the adsorption process and the regeneration process are separately progressed, and thus, the process is very complicated, and facilities and process cost are very high.

In addition, in the adsorption process using activated carbon, chlorosilane compounds are coagulated in a liquid phase on the surface of the activated carbon and easily removed, but since hydrogen chloride forms a physical bond on the surface of the activated carbon in a gas phase due to the low boiling point, it is desorbed at room temperature and thus most hydrogen chloride are discharged without being removed. And, since the molecular weight is low compared to chlorosilane compounds, an additional process should be applied to completely separate from hydrogen.

Thus, problems such as mechanical error of the apparatus, shortening of life, and leakage of chlorosilane compounds, and the like may be caused due to the corrosion by hydrogen chloride, and the purity of polysilicon may be influenced.

### DISCLOSURE

### Technical Problem

In order to solve the problems of the prior art, it is an object of the present invention to provide a method for purification of off-gas that may effectively remove hydrogen chloride gas from the off-gas generated in a polysilicon deposition process by chemical vapor deposition (CVD), and a device for the same.

### Technical Solution

The present invention provides a method for purifying off-gas comprising preparing a carbon support on which a transition metal catalyst is supported; and passing off-gas comprising hydrogen chloride (HCl), hydrogen (H₂), and chlorosilane compounds through the carbon support to remove hydrogen chloride.

The present invention also provides a device for purification of off-gas comprising

a catalytic reactor that comprises a transition metal catalyst-supported carbon support, and passes off-gas comprising hydrogen chloride (HCl), hydrogen (H₂), and chlorosilane compounds to remove hydrogen chloride; and

a separator for separating hydrogen and chlorosilane compounds through the off-gas that has passed through the catalytic reactor.

### Advantageous Effects

According to the method and device for purification of off-gas, hydrogen chloride may be effectively removed from off-gas, and a lot of problems caused by hydrogen chloride, for example, corrosion, leakage of chlorosilane, change in a separation membrane, elution of impurities in activated carbon, and the like may be decreased. Thus, hydrogen chloride-removed hydrogen of high purity may be prepared.

And, the method for purification of off-gas of the present invention may be realized by a comparatively simple and low energy device, facilities and process operation costs may be reduced.

### BRIEF DESCRIPTION OF DRAWINGS

FIG. 1 shows a device for purification of off-gas according to one example of the invention.

FIG. 2 shows a device for purification of off-gas according to another example of the invention.

FIG. 3 shows a device for purification of off-gas according to another example of the invention.

FIG. 4 is a graph measuring the compositions of off-gas over time in Example 1 and Comparative Example 1.

FIG. 5 is a graph measuring the content of hydrogen chloride in off-gas over time by GC in Example 1 and Comparative Example 1.

### DETAILED DESCRIPTION OF THE INVENTION

As used herein, the terms ‘a first’, ‘a second’ and the like are used to explain various constitutional elements, and they are used only for the purpose of distinguishing one constitutional element from other constitutional elements.

And, the terms used herein are only to explain exemplary examples, and are not intended to limit the invention. A singular expression includes a plural expression unless otherwise means clearly in the context. As used herein, the terms “comprising”, “equipped” or “having” and the like are to designate the existence of practiced characteristic, number, step, constitutional element or combinations thereof, and should be understand not to exclude the possibility of addition or existence of one or more other characteristics, numbers, steps, constitutional elements or combinations thereof.

And, if a layer or an element is mentioned to be formed “on” or “above” layers or elements, it means that each layer or element is directly formed on the layers or elements, or that other layers or elements may be formed between the layers, subjects, or substrates.

Although various modifications may be made to the present invention and the invention may have various forms, hereinafter, specific examples will be illustrated and explained in detail. However, these are not to limit the invention to specific disclosure, and it should be understood that the present invention includes all modifications, equivalents or substituents within the idea and technical scope of the invention.

Hereinafter, a method and a device for purification of off-gas according to the present invention will be explained in detail.

According to one embodiment of the invention, there is provided a method for purification of off-gas comprising preparing a carbon support on which a transition metal catalyst is supported; and passing off-gas comprising hydrogen chloride (HCl), hydrogen (H₂), and chlorosilane compounds through the carbon support to remove hydrogen chloride.

First, the subject of the purification method of the present invention is off-gas comprising hydrogen chloride (HCl), hydrogen (H₂), and chlorosilane compounds, and it may be derived from various processes, particularly, it may be gas discharged after conducting a polysilicon deposition process by chemical vapor deposition (CVD).

Chemical vapor deposition (CVD), one of the methods known to produce polysilicon, refers to a process of heating silicon filament, and then, injecting silicon precursor compounds of gas state such as trichlorosilane to thermally decompose, thereby depositing silicon on the silicon filament.

As the by-products of the polysilicon deposition process by chemical vapor deposition, chlorosilane compounds such as dichlorosilane (SiH₂Cl₂), trichlorosilane (SiHCl₃), and silicon tetrachloride (SiCl₄), and off-gas containing hydrogen chloride (HCl) and hydrogen (H₂) are generated.

Hydrogen and chlorosilane compounds may be separated from various components in the off-gas, and recycled to chemical vapor deposition. However, among the components in the off-gas, hydrogen chloride is difficult to recycle and may cause corrosion of devices, and thus, it may be preferable to remove it after conducting the process, but it is not easy to remove it due to the low boiling point and molecular weight.

In the existing purification method of off-gas, off-gas discharged from a polysilicon deposition reactor is transferred to a condensation and compression process and separation was conducted. Thereby, condensed phase stream comprising chlorosilane compounds is transferred to the top of a distillation column, and non-condensed phase stream is transferred to the bottom of a distillation column after cooled and compressed.

The condensed phase stream from which hydrogen chloride (HCl) components has been removed in the distillation column is sprayed and mixed on top of the absorption column, and absorbs chlorosilane and hydrogen chloride (HCl) in the non-condensed phase stream and removes them.

And then, hydrogen stream from which most chlorosilane and hydrogen chloride have been removed is introduced into a column filled with activated carbon, remaining hydrogen chloride and chlorosilane compounds are adsorbed by the activated carbon, and high purity hydrogen is recovered.

This purification method is a pressure swing adsorption (PSA) process, and it has disadvantages in that it has low energy efficiency because it consists of condensation and compression processes, and has high maintenance repair cost because it is a physical process. And, in the pressure swing adsorption process, the adsorption process is a process of selectively adsorbing desired gas to be removed among hydrogen chloride, hydrogen and chlorosilane compounds, thereby preparing high purity hydrogen, and the activated carbon regeneration process is a process of desorbing adsorbed materials from the adsorbent contaminated with hydrogen chloride and chlorosilane compounds, and the adsorption process and the regeneration process are alternatively conducted in at least two adsorption columns. As such, the existing pressure swing adsorption process is a very complicated process because the adsorption process and the regeneration process are separately progressed, and facilities and process costs are significantly high.

And, according to the pressure swing adsorption process, chlorosilane compounds are condensed in a liquid phase on the surface of activated carbon and thus easily removed, but hydrogen chloride forms a physical bond in a gas phase on the surface of activated carbon due to the low boiling point, and thus, it is desorbed at room temperature, and most hydrogen chloride are discharged without being removed. Thus, problems such as mechanical malfunction, shortening of life, outflow of chlorosilane, and the like may be caused due to corrosion by hydrogen chloride.

Particularly, impurities such as phosphorous (P), iron (Fe), calcium (Ca) included in the activated carbon itself may react with hydrogen chloride and be eluted. Particularly, phosphorous should be completely removed because it performs a function as a donor supplying electrons to silicon semiconductor, but it may react with hydrogen chloride to form phosphorous compounds (PCl₃, PH₃). Particularly, PH₃, which has a boiling point of −87.7° C., is discharged together with hydrogen to influence on the purity of polysilicon.

Thus, according to the purification method of off-gas of the present invention, hydrogen chloride may be effectively removed from the off-gas by a carbon support on which a transition metal catalyst is supported, and a lot of problems that may be caused by hydrogen chloride, such as corrosion, outflow of chlorosilane, change of a separation membrane, elution of impurities included in activated carbon, and the like, may be prevented. Thus, high purity hydrogen from which hydrogen chloride has been removed may be separated.

And, the purification method of off-gas of the present invention may be realized by a relatively simple and low energy device compared to the conventional pressure swing adsorption process, and it may reduce facilities and process operation costs.

In the purification method of off-gas of the present invention, a carbon support on which a transition metal catalyst is supported is prepared, and off-gas comprising hydrogen chloride (HCl), hydrogen (H₂), and chlorosilane compounds is passed through the carbon support to remove hydrogen chloride.

The carbon support on which a transition metal catalyst is supported may be prepared by mixing a solution comprising a transition metal catalyst with a carbon support, and then, removing solvent in the solution, but is not limited thereto. And, the solvent for the transition metal catalyst may be water, or alcohols, but is not limited thereto.

More specifically, by impregnating the carbon support in a solution comprising the transition metal catalyst and dispersing the solution on the surface of the carbon support, and then, removing the solvent, or by dissolving the transition metal catalyst in distilled and deionized water to form a uniform solution, introducing it in a syringe or a burette, dropping it in the carbon support by drops while stirring so as to be permeated in the micropores of the carbon support, and then, putting in a drier and removing the moisture, the transition metal catalyst may be supported on the surface of the carbon support.

And, the transition metal catalyst may be selected from the group consisting of platinum, palladium, ruthenium, nickel, iridium, rhodium, and compounds thereof, and the compound may include oxides, hydrides, organic metal compounds, composite metal oxides, and the like, but is not limited thereto. According to one example of the invention, the transition metal may be preferably platinum (Pt).

The carbon support is not specifically limited as long as it may become a support of the above explained transition metal catalyst, but it may be activated carbon, carbon nanotubes, carbon nanoribbons, carbon nanowires, porous carbon, carbon powder, or carbon black. The carbon support supports the transition metal catalyst to increase the specific surface area of the transition metal catalyst, and it prevents coagulation so that uniform and efficient catalytic reaction may occur.

However, small amounts of impurities such as aluminum (Al), iron (Fe), magnesium (Mg), sodium (Na), zinc (Zn), calcium (Ca), and the like may be included in the carbon support. The impurity elements included in the carbon support may react with hydrogen chloride and be eluted, and the eluted components inhibit purity of polysilicon, and thus, it is required for the impurity elements not to be eluted when purifying off-gas. In this regard, to remove impurities included in the carbon support and increase specific surface area, a pretreatment process may be conducted on the carbon support. The pretreatment process may be conducted, for example, by introducing inert gas such as Ar, H₂, N₂, and the like, heating at a temperature of about 200° C. or more and under pressure of about 1 to 2 atm, and then, cooling to room temperature. Alternatively, in case a large amount of impurities are included in the carbon support, a step of removing foreign substances on the surface of the carbon support with an acid solution such as HCl, and washing with deionized water may be further conducted, before introduction of the inert gas and heating.

According to one example of the invention, the transition metal catalyst may be supported in the content of about 0.01 to about 20 wt %, preferably about 0.1 to about 10 wt %, more preferably about 0.1 to about 5 wt %, based on total weight of the carbon support. Although purification efficiency increases as the amount of the transition metal catalyst increases, the above amount may sufficiently achieve yield improvement effect in terms of commercial and economical terms.

According to the purification method of the invention, hydrogen chloride in the off-gas may be converted into trichlorosilane (SiHCl₃) and silicon tetrachloride (SiCl₄) by the following Reaction Formula 1 and/or 2 while passing through the transition metal catalyst supported carbon support. Thereby, the concentration of hydrogen chloride itself is lowered, and simultaneously, elution of the impurities in the carbon support may be prevented.

SiH₂Cl₂+HCl→SiHCl₃+H₂ [Reaction Formula 1]

SiHCl₃+HCl→SiCl₄+H₂ [Reaction Formula 2]

In accordance with the Reaction Formula 1 and/or 2, as the off-gas comprising hydrogen chloride, hydrogen and chlorosilane compounds passes through a transition metal supported carbon support, hydrogen chloride may be converted into trichlorosilane and/or silicon tetrachloride.

According to the present invention, the ratio of each component included in the off-gas is not specifically limited. In case the off-gas is gas discharged after conducting a polysilicon deposition process by chemical vapor deposition, hydrogen may be about 50 mol % or more of total off-gas, and the remainder may be hydrogen chloride and chlorosilane compounds. And, the mole ratio of hydrogen (H₂) and hydrogen chloride (HCl) may be about 99:1. Meanwhile, to more effectively remove hydrogen chloride, trichlorosilane may be included in the mole number of one or more, based on 1 mole of hydrogen chloride (HCl).

The content of hydrogen chloride in total off-gas may be decreased about 80 to 100%, preferably about 90 to about 99.9%, based on mole number, compared to that before passing the transition metal catalyst supported carbon support.

And, compared to the case of passing through a carbon support on which the transition metal catalyst is not supported, about 25% or more of hydrogen chloride may be further removed.

The step of passing the off-gas through the transition metal catalyst supported carbon support may be conducted at a temperature of about 20 to about 500° C., preferably about 50 to about 200° C. and under pressure of about 1 to about 30 bar, preferably about 1 to about 20 bar, but is not limited thereto, and the conditions may be appropriately modified within the range where the transition metal catalyst is activated.

Next, a separation process for separating hydrogen and chlorosilane compounds from the off-gas passing through the carbon support is conducted.

The separation process is not specifically limited as long as it may separate high boiling point compounds and low boiling point compounds from mixed gas, and for example, it may be conducted by a distillation process, a separation membrane process, a gas liquid separation process, or combinations thereof.

More specifically, according to one example of the invention, first, the off-gas passing through the carbon support is introduced in a primary distillation column. From the top of the primary distillation column, hydrogen is discharged, and from the bottom, chlorosilane compounds are discharged. The chlorosilane compounds discharged from the bottom are introduced in a secondary distillation column, from the primary distillation column, dichlorosilane (DCS; SiH₂Cl₂) and trichlorosilane (TCS; SiHCl₃) may be discharged, and from the secondary distillation column, silicon tetrachloride (STC; SiCl₄) may be separated. The separated components other than silicon tetrachloride may be recycled to a supply process for a polysilicon deposition process.

According to another example of the invention, the off-gas passing through the carbon support is primarily cooled, introduced into a knock out drum, and separated into condensed/non-condensed phases. Among the components separated in the knock out drum, the non-condensed phase included in excessive amount of hydrogen may be purified by a separation membrane, and the purified hydrogen may be recycled for a polysilicon deposition process. A condensed-phased stream comprising chlorosilane compounds that has failed to pass through the separation membrane may be introduced in a distillation column, and separated into gas phase of dichlorosilane (DCS; SiH₂Cl₂) and trichlorosilane (TCS; SiHCl₃), and liquid phase of silicon tetrachloride (STC; SiCl₄). The separated components other than silicon tetrachloride may be recycled to a supply process for a polysilicon deposition process.

According to another embodiment of the invention, a device for purification of off-gas is provided that comprises: a catalytic reactor that comprises a transition metal catalyst-supported carbon support, and passes off-gas comprising hydrogen chloride (HCl), hydrogen (H₂), and chlorosilane compounds to remove hydrogen chloride; and a separator for separating hydrogen and chlorosilane compounds through the off-gas that has passed through the catalytic reactor.

The details of the transition metal catalyst-supported carbon support are as explained above in the purification method.

And, the separator is not specifically limited as long as it is a common apparatus capable of separating high boiling point compounds and low boiling point compounds from mixed gas, and for example, it may include a distillation apparatus, a separation membrane apparatus, a knock out drum, a gas liquid separation apparatus, and the like.

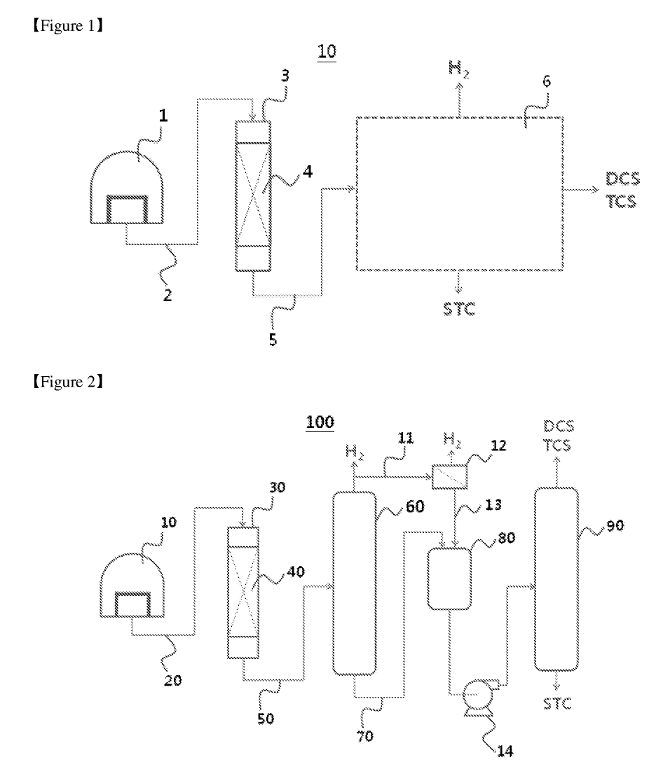

FIG. 1 shows a device for the purification of off-gas according to one example of the invention.

Referring to FIG. 1, the purification device 10 of off-gas according to one example of the invention comprises a catalytic reactor 3 and a distillation column 6

In the catalytic reactor 3, off-gas 2 that is discharged from the polysilicon deposition reactor 1 is transferred for separation and purification. Wherein the off-gas 2 may consist of about 50 mol % or more of hydrogen, about 0.01 to about 5 mol % of hydrogen chloride, about 0.01 to about 10 mol % of dichlorosilane, about 0.01 to about 25 mol % of trichlorosilane, and about 0.01 to about 10 mol % of silicon tetrachloride, but is not limited thereto.

In the catalytic reactor 3, a transition metal catalyst supported carbon support 4 is filled. The off-gas 2 passes through the catalytic reactor 3 that is filled with the transition metal catalyst supported carbon support 4, and hydrogen chloride may be converted into trichlorosilane and/or silicon tetrachloride according to the above explained Reaction Formula 1 and/or in the catalytic reactor 3. The operation temperature of the catalytic reactor 3 may be about 20 to about 500° C., preferably about 50 to about 200° C., but is not limited thereto, and may be changed within a range where the transition metal catalyst supported carbon support 4 is not inactivated. And, the operation pressure may be about 1 to about 30 bar, preferably about 1 to about 20 bar, but it may be changed within a range that does not influence on the activation of the catalyst and the operation of the catalytic reactor 3.

The mixed gas 5 that has passed through the catalytic reactor 3 is transferred to a distillation column 6 that is connected to the back-end of the catalytic reactor 3 for separation and purification. Wherein, the mixed gas 5 that has passed through the catalytic reactor 3 may consist of about 50 mol % or more of hydrogen, about 0.01 to about 5 mol % of dichlorosilane, about 0.01 to about 25 mol % of trichlorosilane, and about 0.01 to about 30 mol % silicon tetrachloride.

In the distillation column 6, the mixed gas 5 is separated into hydrogen, a mixed gas of dichlorosilane and trichlorosilane, and liquid silicon tetrachloride, and it may be recycled to the polysilicon deposition reactor 1 for reuse.

FIG. 2 shows the purification device of off-gas according to another example of the invention.

Referring to FIG. 2, the purification device 100 of off-gas according to one example of the invention comprises a catalytic reactor 30, a primary distillation column 60, and a secondary distillation column 90.

In the catalytic reactor 30, off-gas 20 that is discharged from the polysilicon deposition reactor 10 is transferred for separation and purification. Wherein the off-gas 20 may consist of about 50 mol % or more of hydrogen, about 0.01 to about 5 mol % of hydrogen chloride, about 0.01 to about 10 mol % of dichlorosilane, about 0.01 to about 25 mol % of trichlorosilane, and about 0.01 to about 10 mol % of silicon tetrachloride, but is not limited thereto.

In the catalytic reactor 30, a transition metal catalyst supported carbon support 40 is filled.

The off-gas 20 passes through the catalytic reactor 30 that is filled with the transition metal catalyst supported carbon support 40, and hydrogen chloride may be converted into trichlorosilane and/or silicon tetrachloride according to the above explained Reaction Formula 1 and/or in the catalytic reactor 30. The operation temperature of the catalytic reactor 30 may be about 20 to about 500° C., preferably about 50 to about 200° C., but is not limited thereto, and may be changed within a range where the transition metal catalyst supported carbon support 40 is not inactivated. And, the operation pressure may be about 1 to about 30 bar, preferably about 1 to about 20 bar, but it may be changed within a range that does not influence on the activation of the catalyst and the operation of the catalytic reactor 30.

The mixed gas 50 that has passed through the catalytic reactor 30 is introduced into a primary distillation column 60, from the top of the primary distillation column 60, hydrogen 11 is separated, and from the bottom, chlorosilane compounds 70 are separated. At this time, the primary distillation column 60 may be operated at low temperature equal to or less than the boiling point of dichlorosilane for separation of hydrogen 11 and chlorosilane compounds 70. And, in order to increase separation efficiency, a cooler may be further installed before the primary distillation column 60 to lower the temperature of the mixed gas 50. The chlorosilane compounds 70 that are discharged from the bottom of the primary distillation column 60 may comprise about 5 to about 15 mol % of dichlorosilane, about 40 to about 60 mol % of trichlorosilane, and about 30 to about 50 mol % of silicon tetrachloride.

The chlorosilane compounds 70 are transferred to a storage tank 80. The chlorosilane compounds that are discharged from the storage tank 80 are transferred to a secondary distillation column 90 by a pump 14. From the top of the secondary distillation column 90, dichlorosilane and trichlorosilane are discharged in a gas phase, and from the bottom, silicon tetrachloride is discharged in a liquid phase. The secondary distillation column 90 may be operated between the dew point of silicon tetrachloride and the boiling point of trichlorosilane. The operation pressure of the primary distillation column 60 and the secondary distillation column 90 may be about 0 to about 10 bar, and the boiling point and the dew point of each component are determined by vapor pressure and operation pressure.

Meanwhile, in order to increase the purity of hydrogen discharged from the primary distillation column 60, a separation membrane 12 may be installed, and the whole or a part of hydrogen stream 11 may be introduced therein. And, impurities that are separated from the separation membrane 12 are introduced in a storage tank 80, mixed with the chlorosilane compounds 70 that are discharged from the primary distillation column 60 and may be transferred to the secondary distillation column 90.

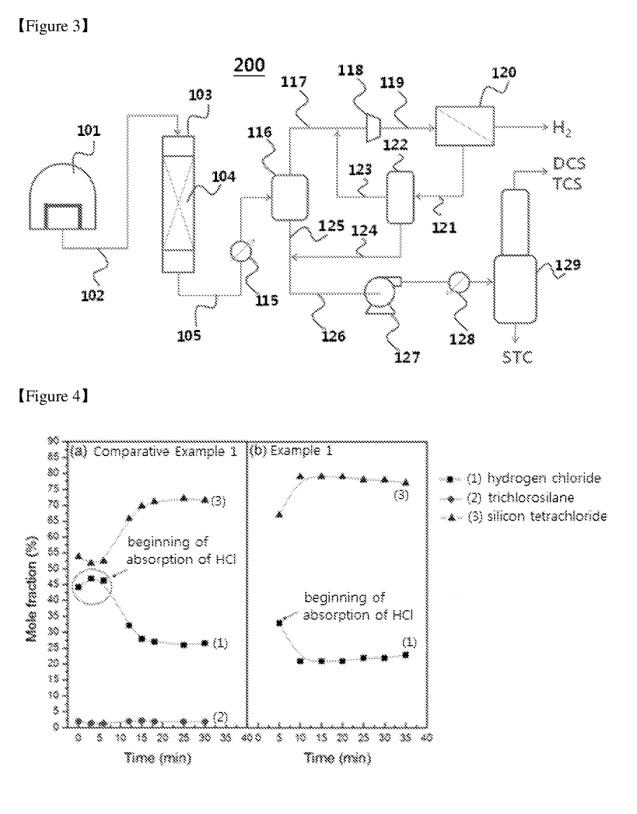

FIG. 3 shows the purification device of off-gas according to another example of the invention.

Referring to FIG. 3, the purification device of off-gas 200 according to one example of the invention comprises a catalytic reactor 103, a knock out drum 116, a separation membrane 120, and a distillation column 129.

In the catalytic reactor 103, off-gas 102 that is discharged from the polysilicon deposition reactor 101 is transferred for separation and purification. Wherein the off-gas 102 may consist of about 50 mol % or more of hydrogen, about 0.01 to about 5 mol % of hydrogen chloride, about 0.01 to about 10 mol % of dichlorosilane, about 0.01 to about 25 mol % of trichlorosilane, and about 0.01 to about 10 mol % of silicon tetrachloride, but is not limited thereto.

In the catalytic reactor 103, a transition metal catalyst supported carbon support 104 is filled.

The off-gas 102 passes through the catalytic reactor 103 that is filled with the transition metal catalyst supported carbon support 104, and hydrogen chloride may be converted into trichlorosilane and/or silicon tetrachloride according to the above explained Reaction Formula 1 and/or in the catalytic reactor 103. The operation temperature of the catalytic reactor 103 may be about 20 to about 500° C., preferably about 50 to about 200° C., but is not limited thereto, and may be changed within a range where the transition metal catalyst supported carbon support 104 is not inactivated. And, the operation pressure may be about 1 to about 30 bar, preferably about 1 to about 20 bar, but it may be changed within a range that does not influence on the activation of the catalyst and the operation of the catalytic reactor 103.

The mixed gas 105 that has passed through the catalytic reactor 103 passes by a cooler 115, is cooled to −5° C. or less and introduced into a knock out drum 116. At this time, to facilitate the transfer of the mixed gas 105, a pump may be installed at the back-end of the cooler 115, or the location of the knock out drum 116 may be located at the back-end of the catalytic reactor 103 to allow the mixed gas to flow by gravity.

The mixed gas stream from the knock out drum 116 is separated into excessive amount of hydrogen and non-condensed phase stream 117 and condensed phased stream 125 of chlorosilane compounds by vapor pressure of each component. The non-condensed phase stream 117 may comprises about 80 mol % or more of hydrogen, and the composition of chlorosilane compounds in the non-condensed phase stream 117 may be determined according to the temperature and the pressure of the knock out drum 116. The non-condensed phase stream 117 is compressed with a compressor 118 to pass through a separation membrane 120, and for example, it may be pressurized to about 3 to about 6 bar or more. The pressurized non-condensed phase stream 119 is separated into high purity hydrogen that has passed through the separation membrane 120 and impurities 121 that has failed to pass through the separation membrane 120. The non-permeable impurities 121 that are discharged from the separation membrane 120 pass by a liquid separator 122 and are separated again into hydrogen stream 123 and chlorosilane condensed phase stream 124, wherein the hydrogen stream 123 is mixed with the non-condensed phased stream 117 that is discharged from the top of the knock out drum 116 and passes by a compressor 118.

The condensed phased stream 125 that is discharged from the bottom of the knock out drum 116 is mixed with chlorosilane-based condensed phase stream 124 that is discharged from the liquid separator 122 and forms chlorosilane-based stream 126. The chlorosilane-based stream 126 is transferred to a distillation column 129 by a pump 127. At this time, before the stream is introduced in the distillation column 129, a heater 128 may be further comprised to increase separation efficiency, and the stream may be heated to about 30 to about 70° C. by the heater 128.

The chlorosilane-based stream 126 that is introduced in the distillation column 129 is separated into a gas phase of dichlorosilane and trichlorosilane and a liquid phase of silicon tetrachloride, and discharged. At this time, the distillation column 129 may be operated at a pressure range of about 3 to about 7 bar, and at a temperature range between the dew point of silicon tetrachloride and the boiling point of silicon tetrachloride, and the dew point of silicon tetrachloride and the boiling point of silicon tetrachloride may be determined by the operation pressure and the vapor pressure of each component.

According to the purification method and device of off-gas of the present invention, by using a carbon support on which a transition metal catalyst is supported, about 25% or more of hydrogen chloride may be removed compared to the case of using only carbon where a catalyst is not supported, and particularly, as the supply amount of trichlorosilane increases, the removal efficiency of hydrogen chloride may be increased.

Hereinafter, the present invention will be explained in detail with reference to specific examples. However, these examples are only to illustrate the invention, and the right scope of the invention is not limited thereto.

### EXAMPLE

### Example 1

Based on activated carbon, 5 wt % of platinum (Pt) catalyst was mixed with methanol containing a small amount of H₂O, and the mixture was coated on the activated carbon, and then, heated at 80° C. in a dry oven to remove methanol and moisture, thereby preparing a carbon support on which a transition metal catalyst is supported (5 wt % Pt/C).

The transition metal catalyst supported carbon support was filled in a catalytic reactor, and then, activated at 150° C., 3 bar, for 1 hour and 30 minutes, to completely remove organic materials and moisture (H₂O) of the activated carbon.

In the catalytic reactor, off-gas that was produced by a polysilicon deposition process by chemical vapor deposition (CVD) was introduced. The off-gas included about 99 mol % of hydrogen (H₂), about 0.5 mol % of hydrogen chloride (HC), about 0.03 mol % of trichlorosilane, and about 0.07 mol % of silicon tetrachloride, based on GC peak area. The operation condition of the catalytic reactor was maintained at 150° C., 20 bar.

### Comparative Example 1

Off-gas was purified by the same method as Example 1, except that only activated carbon on which a transition metal catalyst is not supported was filled in the catalytic reactor column, in Example 1. Wherein, the adsorption condition of the activated column was 20° C., 20 bar.

### Experimental Example

### Evaluation of the Performance of a Catalytic Reactor by Reaction Simulation

### Experimental Example 1

Off-gas was purified using the purification device shown in FIG. 1. In order to confirm the performance, the process was simulated using a process simulation program ASPEN Plus.

The reaction temperature and the pressure of the catalytic reactor 3 were set at 170° C. and 5 barG, and the composition of the stream introduced in the catalytic reactor 3 was set to consist of 1 mol % of hydrogen chloride, 2 mol % of dichlorosilane, 10 mol % of trichlorosilane, 7 mol % of silicon tetrachloride, and 80 mol % of hydrogen. As the catalytic reactor 3, R-Gibbs and R-Stoic models were used.

As the result of simulation under the above conditions, the mixed gas 5 that has passed through the catalytic reactor 3 consisted of 1 mol % of dichlorosilane, 12 mol % of trichlorosilane, 7 mol % of silicon tetrachloride, and 80 mol % of hydrogen, and it was confirmed that hydrogen chloride reacts with dichlorosilane under the given reaction conditions and is removed, and is converted into higher chlorosilane such as trichlorosilane, and the like.

### Experimental Example 2

Off-gas was purified using the purification device shown in FIG. 2. In order to confirm the performance, the process was simulated using a process simulation program ASPEN Plus.

The reaction temperature and the pressure of the catalytic reactor 30 were set at 170° C. and 5 barG, and the composition of the stream introduced in the catalytic reactor 30 was set to consist of 1 mol % of hydrogen chloride, 2 mol % of dichlorosilane, 10 mol % of trichlorosilane, 7 mol % of silicon tetrachloride, and 80 mol % of hydrogen. As the catalytic reactor 30 was R-Gibbs and R-Stoic models were used.

The purification temperature in the primary distillation column 60 was set at −5˜−60° C., and the pressure was set at 23 barG. It was set that the composition of the mixed gas 50 stream introduced in the primary distillation column 60 was identical to the composition obtained as the simulation result for the catalytic reactor 30, which consisted of 1 mol % of dichlorosilane, 12 mole % of trichlorosilane, 7 mol % of silicon tetrachloride, and 80 mol % of hydrogen.

As the simulation result, the stream discharged from the top of the distillation column 60 consisted of 0.01 mol % of dichlorosilane, 0.03 mol % of trichlorosilane, 0.001 mol % of silicon tetrachloride, and 99.96 mol % of hydrogen, and it was confirmed that high purity hydrogen stream is discharged.

### Evaluation of the Adsorption Efficiency for Hydrogen Chloride

### Experimental Example 3

In Example 1 and Comparative Example 1, the compositions of gas before and after passing through the carbon support were compared.

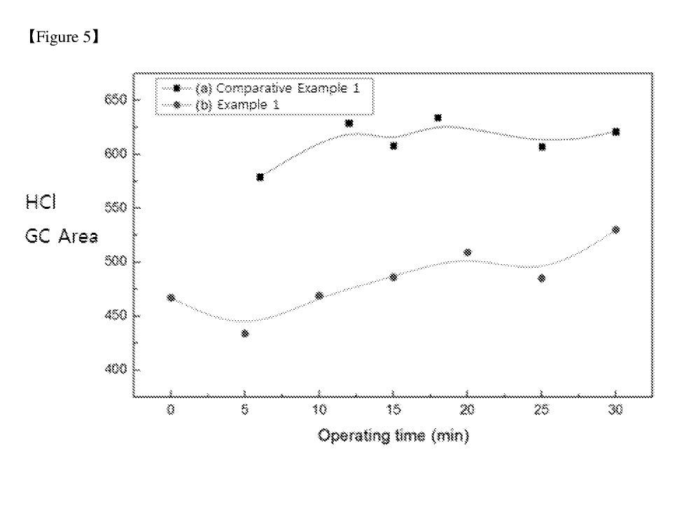

FIG. 4 is a graph measuring the compositions of off-gas over time in Example 1 and Comparative Example 1. In FIG. 4, the sum of chlorosilane and hydrogen chloride compounds except hydrogen was 100 mol %, and relative compositional ratio (mol %) thereto was represented.

FIG. 4(a) shows the change in the composition of the off-gas over time while passing through the carbon support in Comparative Example 1, and FIG. 4(b) shows the change in the composition of the off-gas over time while passing through the transition metal catalyst supported carbon support in Example 1.

As shown in FIG. 4(a), hydrogen chloride finally remains about 26 mol %. It is considered that at the beginning of adsorption (within 5 minutes), most chlorosilane is adsorbed to the carbon support, but as times passes, physical adsorption of the carbon support is lowered, and hydrogen chloride is not adsorbed and passes, and thus, the compositional ratio of hydrogen chloride is relative high.

To the contrary, as shown in FIG. 4(b), in Example 1 wherein a transition metal catalyst supported carbon support is used, the compositional ratio of hydrogen chloride is about 21 mol %, which is about 5% decreased compared to Comparative Example 1, and trichlorosilane (SiHCl₃) is scarcely detected and thus substantially completely removed.

FIG. 5 is a graph measuring the relative contents of hydrogen chloride of the off-gas over time by GC in Example 1 and Comparative Example 1.

As shown in FIG. 5, in Example 1 passing through the transition metal catalyst supported carbon support, the amount of hydrogen chloride is decreased about 25% or more compared to Comparative Example 1 without using a transition metal catalyst.

### DEFINITION OF SYMBOLS

10, 100, 200: purification device
3, 30, 103: catalytic reactor
4, 40, 104: carbon support
6, 129: distillation column
60: primary distillation column
90: secondary distillation column
116: knock out drum

1. A method for purifying off-gas comprising
preparing a carbon support on which a transition metal catalyst is supported; and
passing off-gas comprising hydrogen chloride (HCl), hydrogen (H₂), and chlorosilane compounds through the carbon support to remove hydrogen chloride.

2. The method for purifying off-gas according to claim 1, wherein the transition metal is at least one selected from the group consisting of platinum, palladium, ruthenium, nickel, iridium, rhodium, and compounds thereof.

3. The method for purifying off-gas according to claim 1, wherein the carbon support is selected from the group consisting of activated carbon, carbon nanotubes, carbon nanoribbons, carbon nanowires, porous carbon, carbon powder, and carbon black.

4. The method for purifying off-gas according to claim 1, wherein the transition meal catalyst is supported in the content of 0.01 to 20 wt %, based on total weight of the carbon support.

5. The method for purifying off-gas according to claim 1, wherein the off-gas is gas discharged after conducting a polysilicon deposition process by chemical vapor deposition (CVD).

6. The method for purifying off-gas according to claim 1, wherein the off-gas comprises 50 mol % or more of hydrogen, based on the total off-gas.

7. The method for purifying off-gas according to claim 1, wherein the chlorosilane compound includes dichlorosilane (SiH₂Cl₂), trichlorosilane (SiHCl₃), and silicon tetrachloride (SiCl₄).

8. The method for purifying off-gas according to claim 1, wherein the content of the hydrogen chloride in the off-gas that has passed through the carbon support is decreased 80% or more, based on the mole number, compared to that before passing through the carbon support.

9. The method for purifying off-gas according to claim 1, wherein the step of passing the off-gas through the transition metal catalyst-supported carbon support is conducted under conditions of 20 to 500° C. and 1 to 30 bar.

10. The method for purifying off-gas according to claim 1, wherein as the off-gas passes through the transition metal catalyst-supported carbon support, hydrogen chloride is converted into trichlorosilane and silicon tetrachloride.

11. The method for purifying off-gas according to claim 1, further comprising separating hydrogen and chlorosilane compounds from the off-gas that has passed through the carbon support.

12. The method for purifying off-gas according to claim 11, wherein the step of separating hydrogen and chlorosilane compounds from the off-gas that has passed through the carbon support is conducted by a separation membrane process, a distillation process, a gas liquid separation process, or combinations thereof.

13. A device for purification of off-gas comprising
a catalytic reactor that comprises a transition metal catalyst-supported carbon support, and passes off-gas comprising hydrogen chloride (HCl), hydrogen (H₂), and chlorosilane compounds to remove hydrogen chloride; and
a separator for separating hydrogen and chlorosilane compounds from the off-gas that has passed through the catalytic reactor.

14. The device for purification off-gas according to claim 13, wherein the separator includes at least one selected from the group consisting of a distillation apparatus, a separation membrane apparatus, and a gas liquid separation apparatus.
